(19) United States
(12) Patent Application Publication
(10) Pub. No.: US 2019/0205983 A1
(43) Pub. Date: Jul. 4, 2019

(54) COMPUTER SYSTEM AND COMPUTER-IMPLEMENTED METHOD FOR USING FINANCIAL ASSETS

(71) Applicant: Mastercard International Incorporated, Purchase, NY (US)

(72) Inventors: Arunmurthy Gurunathan, Pune (IN); Ganesh Shinde, Pune (IN); Ketan Shrikant Joshi, Pune (IN); Gaurav K. Patni, Pune (IN)

(73) Assignee: Mastercard International Incorporated, Purchase, NY (US)

(21) Appl. No.: 16/225,031

(22) Filed: Dec. 19, 2018

(30) Foreign Application Priority Data
Jan. 3, 2018 (SG) 10201800056Q

(51) Int. Cl. G06Q 40/04; G06Q 40/02; G06Q 40/06; G06Q 20/42

(52) U.S. Cl. CPC G06Q 40/04; G06Q 20/42; G06Q 40/06; G06Q 40/02

(57) ABSTRACT

A server for processing a payment transaction initiated by a customer using various financial assets is described. The server comprising a transaction module, an inquiry module and an authorisation module. The transaction module is configured to: (i) receive a transaction authorisation request comprising at least a payment amount and an account identifier associated with the customer; and (ii) transmit a transaction authorisation response indicating if the payment transaction is approved or refused. The inquiry module is configured to: (i) determine if an available balance of a primary account associated with the account identifier is less than the payment amount; and (ii) determine if the account identifier is associated with a secondary account if the available balance of the primary account is less than the payment amount, the secondary account being associated with a customer financial asset. The authorisation module is configured to: (i) transmit, to a customer electronic device, an authorisation request if it is determined that the customer is associated with the secondary account, the authentication request comprising a request to process the payment transaction using the customer financial asset; and (ii) receive, from the customer electronic device, an authorisation response indicating if the payment transaction is to be processed using the customer financial asset.

### CROSS REFERENCE TO RELATED APPLICATIONS

This application claims priority to Singaporean Application Serial No. 10201800056Q, filed Jan. 3, 2018, which is incorporated herein by reference in its entirety

### FIELD OF THE INVENTION

The present invention relates to a computer system and computer-implemented method for using financial assets. In particular, the invention relates to improving convenience of using financial assets.

### BACKGROUND OF THE INVENTION

Many investment options are available to customers at present. For example, customers may invest in stocks, bonds, properties and commodities etc. Different investment options suit different needs of the customers.

Among the different investment options, shares or commodities are popular assets which can be traded on a daily basis. Shares or commodities are often seen as flexible assets because they can be traded either on a short term or a long term basis. Nonetheless, even though they may be considered as a relatively liquid asset given the flexibility of trading shares or commodities within their respective trading hours, they cannot be used readily by customers since shares or commodities have to be sold before they are liquid.

Other forms of investment options/assets such as fixed deposits, funds and bonds are popular among more risk-averse investors. However, these options may often have a lock-in period which makes them less readily available to customers in case of a need for liquidity.

It is therefore an aim of the present invention to provide a computer system and computer-implemented method to improve convenience for using these financial assets.

### SUMMARY OF THE INVENTION

In accordance with a first aspect of the present invention, there is provided a server for processing a payment transaction initiated by a customer using various financial assets. The server comprising:

a transaction module configured to:
receive a transaction authorisation request comprising at least a payment amount associated with the payment transaction and an account identifier associated with the customer; and
transmit a transaction authorisation response indicating if the payment transaction is approved or refused; and

an inquiry module configured to:
determine if an available balance of a primary account associated with the account identifier is less than the payment amount; and
   determine if the account identifier is associated with a secondary account if the available balance of the primary account is less than the payment amount, the secondary account being associated with a customer financial asset; and

an authorisation request module configured to:
transmit, to a customer electronic device, an authorisation request if it is determined that the customer is associated with the secondary account, the authentication request comprising a request to process the payment transaction using the customer financial asset; and
receive, from the customer electronic device, an authorisation response indicating if the payment transaction is to be processed using the customer financial asset.

Embodiments of the invention therefore provide a server that can be used for processing a payment transaction initiated by a customer using various financial assets. In particular, in processing the payment transaction, if it is determined that a primary account associated with the customer and used to initiate the payment transaction has insufficient funds (i.e. an available balance in the primary account is less than a payment amount associated with the payment transaction), the server is configured to determine if the customer (via the account identifier) is associated with a secondary account. The secondary account is associated with a customer financial asset. If it is determined that the customer is associated with the secondary account, the server is configured to transmit an authorisation request to the customer via a customer electronic device comprising a request to process the payment transaction using the customer financial asset. If an authorisation response indicating that the payment transaction is to be processed using the customer financial asset is received from the customer, the payment transaction may proceed by utilising the customer financial asset. This advantageously provides a new fallback option for the customer to pay for the payment transaction which would otherwise be rejected due to insufficient funds in the primary account (e.g. cash or a credit limit of a payment card etc.). Moreover, with the ease of using other financial assets (e.g. shares, commodities, bonds etc.) readily as a liquid asset (e.g. cash), embodiments of the invention advantageously improve customer experience and provide options in investing in various financial assets which would otherwise limit a liquidity/cash flow of the customer.

In addition, embodiments of the invention may advantageously use present infrastructure for processing the payment transaction using the customer financial asset so that minimal costs will be incurred to implement the above. The primary set-up required is to maintain profiles of customers registered to use financial assets for processing payment transactions which link up primary account(s) (e.g. cash/current/saving accounts, debit/credit card accounts etc.) and secondary account(s) (e.g. shares/equities, commodities, and other not-so-liquid assets) of the customers. This can be easily implemented using existing memory storages, servers and/or databases.

The server may comprise a registration module configured to:
receive, from the customer electronic device, a registration request comprising a request to register to use various financial assets for processing the payment transaction; and
transmit, to the customer electronic device, a registration response indicating if the registration request is approved or refused.

In accordance with a second aspect of the present invention, there is provided a computer-implemented method for processing a payment transaction initiated by a customer using various financial assets, the method comprising:
receiving a transaction authorisation request comprising at least a payment amount associated with the payment transaction and an account identifier associated with the customer;
determining if an available balance of a primary account associated with the account identifier is less than the payment amount;
determining if the account identifier is associated with a secondary account if the available balance of the primary account is less than the payment amount, the secondary account being associated with a customer financial asset;
transmitting, to a customer electronic device, an authorisation request if it is determined that the customer is associated with the secondary account, the authentication request comprising a request to process the payment transaction using the customer financial asset;
receiving, from the customer electronic device, an authorisation response indicating if the payment transaction is to be processed using the customer financial asset; and
transmitting a transaction authorisation response indicating if the payment transaction is approved or refused.

The method may comprise:

receiving, from the customer electronic device, a registration request comprising a request to register to use various financial assets for processing the payment transaction; and

transmitting, to the customer electronic device, a registration response indicating if the registration request is approved or refused.

Using the customer financial asset for processing the payment transaction may comprise selling or mortgaging shares or commodities.

Where using the customer financial asset for processing the payment transaction comprises selling the shares or the commodities, the method may comprise receiving, from the customer electronic device, price margins of the shares or the commodities within which the shares or the commodities are to be sold.

Where using the customer financial asset for processing the payment transaction comprises selling the shares or the commodities, the method may comprise receiving, from the customer electronic device, a selection of the shares or the commodities associated with the secondary account for use in processing the payment transaction.

Where using the customer financial asset for processing the payment transaction comprises mortgaging the shares or the commodities, the method may comprise:
transmitting, to the customer electronic device, a mortgage selection request comprising a mortgage option, the mortgage option being associated with mortgaging the shares or the commodities;
receiving, from the customer electronic device, a mortgage selection response indicating the mortgage option selected for use in processing the payment transaction;
retrieving a current market value associated with the selected mortgage option;
calculating an eligible loan amount associated with the current market value of the selected mortgage option;
transmitting, to the customer electronic device, a repayment selection request comprising the eligible loan amount and a repayment plan associated with the mortgage option, the repayment plan is associated with conditions for repayment of a mortgage amount, the mortgage amount is a monetary amount less than or equal to the eligible loan amount, which is being loaned to the customer by mortgaging the shares or the commodities; and
receiving, from the customer electronic device, a repayment selection response indicating the repayment plan and the mortgage amount selected by the customer.

Where using the customer financial asset for processing the payment transaction comprises mortgaging the shares or the commodities, the method may comprise:
calculating, based on the eligible loan amount, a threshold value associated with the shares or the commodities below which the shares or the commodities are to be sold;
transmitting, to the customer electronic device, a threshold value authorisation request comprising the threshold value and a request for authorisation to sell the shares or the commodities if a value of the shares or the commodities fall below the threshold value; and
receiving, from the customer electronic device, a threshold value authorisation response comprising an approval or a refusal to authorise selling the shares or the commodities if the value of the shares or the commodities fall below the threshold value.

The method may comprise setting a transaction threshold associated with processing the payment transaction using the shares or the commodities.

The method may comprise calculating the transaction threshold based on a profile of the customer, the profile of the customer being associated with a total value of the financial assets associated with the customer, a credit history of the customer, and/or an income of the customer.

The method may comprise receiving, from the customer electronic device, an equity priority list comprising a list of the shares or the commodities in order of preference for use in processing the payment transaction.

The method may comprise receiving, from the customer electronic device, a payment priority list comprising a list of payment options in order of preference for use in processing the payment transaction via at least the primary account and the secondary account, the list of payment options comprises a credit card, a debit card, shares, commodities and/or fixed deposits.

The method may comprise:
determining if the customer identifier is associated with more than one secondary account;
determining if the more than one secondary account is associated with a pre-defined priority, the pre-defined priority being associated with the customer identifier and defines a priority for using the more than one secondary account in processing the payment transaction; and
ranking the more than one secondary account using the pre-defined priority, wherein at least a highest ranking secondary account is used in processing the payment transaction.

The method may comprise:
determining if the customer identifier is associated with more than one secondary account;
determining if the more than one secondary account is associated with pre-determined rules, the pre-determined rules being associated with the customer identifier and are used for ranking the more than one secondary account in processing the payment transaction; and
ranking the more than one secondary account using the pre-determined rules, wherein at least a highest ranking secondary account is used in processing the payment transaction.

The method may comprise:
determining if the customer identifier is associated with more than one secondary account; and
receiving, from the customer electronic device, a selection indicator (e.g. 1, 2, 3 etc.) for selecting one of the more than one secondary account for use in processing the payment transaction.

The method may further comprise transmitting, to the customer electronic device, a selection request to input the selection indicator of the more than one secondary account for use in processing the payment transaction.

The primary account may be associated with another customer financial asset.

In accordance with a third aspect of the present invention, a non-transitory computer-readable medium having stored thereon program instructions for causing at least one processor to perform the preceding method.

In accordance with a fourth aspect of the present invention, there is provided a computer-implemented method for processing a payment transaction initiated by a customer using various financial assets, the method comprising:
receiving a transaction authorisation request comprising at least a payment amount associated with the payment transaction and an account identifier associated with the customer, the account identifier is associated with a customer asset account wherein the customer asset account is associated with a customer financial asset;
transmitting, to a customer electronic device, an authorisation request comprising a request to process the payment transaction using the customer financial asset;
receiving, from the customer electronic device, an authorisation response indicating if the payment transaction is to be processed using the customer financial asset; and
transmitting a transaction authorisation response indicating if the payment transaction is approved or refused.

The customer financial asset may comprise shares, commodities, equities, fixed deposits and/or bonds associated with the customer.

The present invention aims to provide a new and useful computer system and computer-implemented method for processing a payment transaction initiated by a customer using various financial assets to improve convenience and enhance customer experience through providing a new payment option (i.e. use of financial assets) for the payment transaction.

### BRIEF DESCRIPTION OF THE DRAWINGS

Non-limiting embodiments of the invention will now be described for the sake of example only, with reference to the following drawings in which:

FIG. 1 shows a computer system for processing a payment transaction using various financial assets in accordance with an embodiment of the invention;

FIG. 2 shows steps of a method for processing the payment transaction using various financial assets in accordance with an embodiment of the invention;

FIG. 3, comprising FIG. 3A and FIG. 3B, shows steps for registering to use various financial assets for processing the payment transaction in accordance with an embodiment of the invention, where FIG. 3A shows steps of a method for registration of the customer and FIG. 3B illustrates a process flow for registration of the customer;

FIG. 4 shows additional steps of a method for processing the payment transaction using various financial assets in accordance with an embodiment of the invention;

FIG. 5 shows additional steps of a method for processing the payment transaction using various financial assets in accordance with an embodiment of the invention;

FIG. 6 shows schematically a functional structure of the server which may be used in the computer system shown in FIG. 1 to implement a method in accordance with an embodiment of the invention; and

FIG. 7 shows schematically a hardware structure of a server which may be used in the computer system of FIG. 1 to implement a method in accordance with an embodiment of the invention.

### DETAILED DESCRIPTION OF THE EMBODIMENT

As used in this document, the term “financial asset” refers to any form of useful or valuable item or property owned by a person or a company or an entity. In particular, there are various forms of assets which may be associated with a customer, such as, cash and cash equivalents, credit, securities, stocks/shares, commodities, bonds, fixed deposits, properties, equities, intellectual properties, goodwill, equipment, inventory, prepaid cards etc.

Note that the term “payment card” refers to any electronic cashless payment vehicle associated with a payment account, such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, NFC-enabled devices, and/or computers.

Note that the term “institution” is used here in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in this application, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

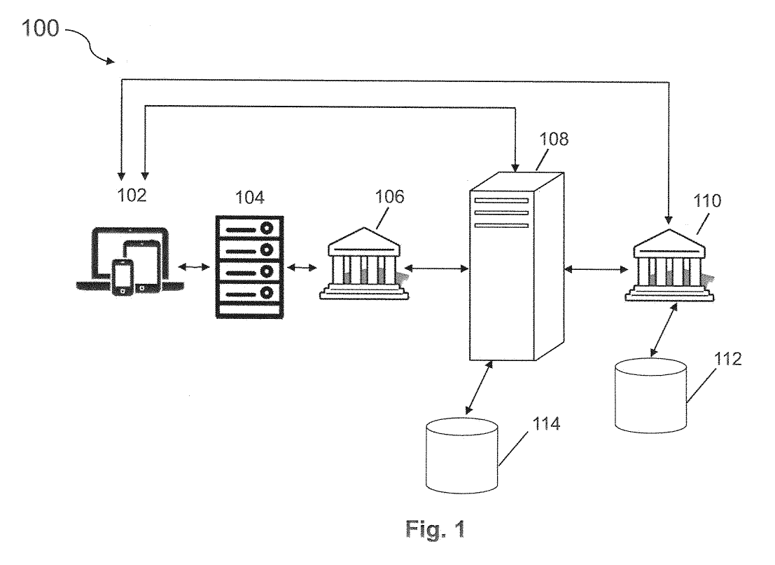

FIG. 1 shows a computer system 100 for a payment transaction initiated by a customer using various financial assets in accordance with an embodiment of the invention. The computer system 100 comprises a payment network server 108 which facilitates a payment transaction between a customer and a merchant. The payment network server 108 is a server associated with a payment network such as the Banknet payment network operated by MasterCard®. As shown in FIG. 1, the payment network server 108 is in communication with an acquirer server 106 and an issuer server 110. The acquirer server 106 is operated by an acquirer institution at which the merchant maintains a merchant account to receive funds. The issuer server 110 is associated with an issuer institution which maintains at least a primary account which can be used for payment in payment transactions (e.g. card-not-present payment transactions using an e-commerce website or physical in-store payment transactions at a point-of-sale (POS) terminal). The issuer institution may maintain secondary account(s) associated with financial assets. In this way, the issuer institution provides various accounts to the customer for performing payment transactions over the payment network. The computer system 100 further comprises a customer electronic device 102 and a merchant server 104. The customer electronic device 102 is any electronic device which enables the customer to purchase product(s) online through e-commerce sites or at a POS terminal associated with a merchant. The customer electronic device 102 may be a mobile phone, a laptop/notebook, a desktop, a tablet, a personal digital assistant (PDA), a key fob, a transponder device, a NFC-enabled device, and/or a computer. The merchant server 104 may be associated with a POS terminal in a merchant's shop or an e-commerce site on which payment transactions can be initiated. Moreover, an issuer database 112 is operationally connected to the issuer server 110. The issuer database 112 serves at least to store data related to primary account(s) and/or secondary account(s) associated with the customer and issued by the issuer institution. The issuer database 112 may store data related to a profile of the customer, where the profile of the customer may be associated with a total value of the financial assets known to the issuer institution and associated with the customer, a credit history of the customer, and/or an income of the customer. In some embodiments, a payment network database 114 may be operationally connected to the payment network server 108. The payment network database 114 may store data related to primary account(s) and/or secondary account(s) associated with the customer. The payment network database 114 may store data related to a profile of the customer, where the profile of the customer may be associated with at least a credit history of the customer.

The present invention aims to build upon present infrastructures for processing payment transactions. In particular, in an event where it is determined that there is insufficient credit limit/fund in a primary account (e.g. a credit/debit card account of the customer) to perform the payment transaction, financial assets associated with a secondary account (e.g. a trading account of the customer) may be utilised for processing the payment transaction. For example, a typical payment transaction may involve a transaction authorisation request being transmitted from the merchant server 104 (either associated with a POS terminal or a merchant e-commerce website) to the payment network server 108 via the acquirer server 106. The transaction authorisation request may comprise payment details such as a payment amount for the payment transaction and an account identifier associated with the customer (e.g. a customer payment card number or a customer account number). The payment details may comprise an expiry date and a card verification code (CVC) associated with the customer payment card, and/or a name of the customer. The payment network server 108 is configured to receive the transaction authorisation request. The payment network server 108 is configured to identify the issuer institution associated with the account identifier used for processing the payment transaction and to transmit a request for authorisation (i.e. the transaction authorisation request) to the issuer server 110 associated with the issuer institution.

In order to authorise the payment transaction, the issuer server 110 may be configured to (i) verify the CVC code and/or (ii) whether the expiry date of the payment card is still valid etc. The issuer server 110 may be configured to check an available balance of a primary account associated with the account identifier to determine if the available balance is more than the payment amount (or conversely, if the available balance is less than the payment amount). The available balance may comprise any overdraft balance available to the primary account. Typically, the payment transaction proceeds with using the primary account if it is determined that there is sufficient fund in the primary account.

In some embodiments, the primary account is associated with a commodity or other financial asset. In other words, in some embodiments, the customer may use his/her financial asset(s) to pay directly for the payment transaction. Therefore, some embodiments of the present invention provide a computer-implemented method for processing a payment transaction initiated by a customer using various financial assets, where the method comprises: (i) receiving a transaction authorisation request comprising at least a payment amount associated with the payment transaction and an account identifier associated with the customer, the account identifier is associated with a customer asset account wherein the customer asset account is associated with a customer financial asset; (ii) transmitting, to a customer electronic device, an authorisation request comprising a request to process the payment transaction using the customer financial asset; (iii) receiving, from the customer electronic device, an authorisation response indicating if the payment transaction is to be processed using the customer financial asset; and (iv) transmitting a transaction authorisation response indicating if the payment transaction is approved or refused. In particular, the customer financial asset may comprise shares, commodities, equities, fixed deposits and/or bonds associated with the customer.

In embodiments of the present invention, if it is determined that the available balance of the primary account is less than the payment amount, the issuer server 110 is configured to determine if the customer is associated with a secondary account where the secondary account is associated with a customer financial asset. The customer financial asset may comprise shares, commodities, equities, fixed deposits and/or bonds associated with the customer. In some embodiments where the primary account is associated with a financial asset associated with the customer, the secondary account is associated with another financial asset associated with the customer. If it is determined that the customer is associated with the secondary account, the issuer server 110 is configured to transmit an authorisation request to process the payment transaction using the customer financial asset. The authorisation request may comprise a dynamic one-time-password (OTP) which is transmitted from the issuer server 110 to the customer via the customer electronic device 102 for further authentication of the authorisation request.

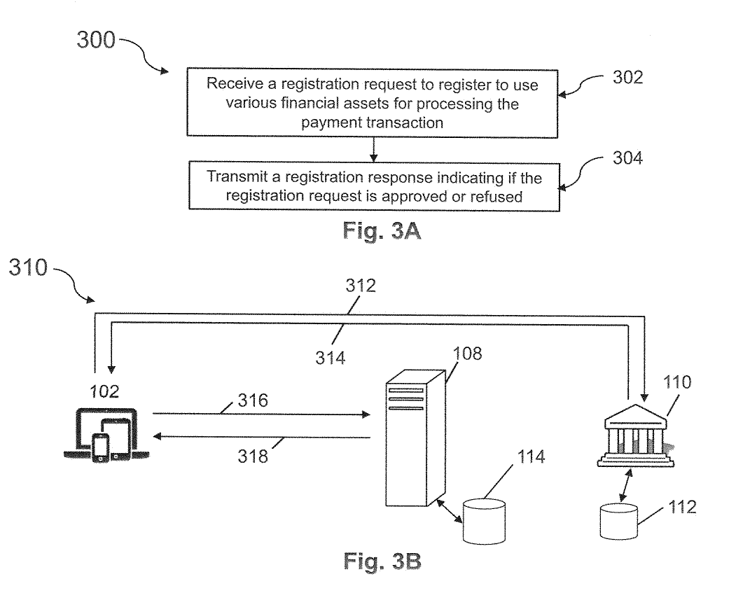

In some embodiments, the customer may be associated with more than one secondary account. The more than one secondary account may be associated with a pre-defined priority which may be pre-determined by the customer when the customer registers to use various financial assets for processing the payment transaction (see e.g. FIG. 3 and description thereof for more detail of a registration process to use various financial assets for processing the payment transaction). The customer may define pre-determined rules such that the rules can be used to determine which secondary account to utilise for processing the payment transaction. The rules may be selected or defined when the customer registers to use various financial assets for processing the payment transaction. The rules may include deriving a potential maximum profit for the customer by selecting a secondary account with minimum returns for use in the payment transaction or otherwise by selecting a secondary account that can capitalised the maximum profit margin at the time of processing the payment transaction etc. In any case, such rules may be provided to the customer where the customer can determine which rules to use as he/she prefers. As such, in some embodiments where it is determined that the customer is associated with more than one secondary account, the authorisation request may comprise a list of secondary accounts for the customer to select from for processing the payment transaction. The list of secondary accounts may be ranked according to the pre-defined priority or the pre-determined rules as described previously. In some embodiments, the list of secondary accounts is not comprised in the authorisation request and is sent in a separate request by the server 108, 110 to the customer for selecting a secondary account for processing the payment transaction. In some embodiments, the secondary account to be used for processing the payment transaction is determined automatically by the server 108, 110 using the pre-defined priority or pre-determined rules as described above so no list is provided for selection by the customer. In some embodiments, the customer is provided with an option to submit details of secondary accounts from which he/she would like to process the payment transaction from. The customer may submit details of more than one secondary account. The more than one secondary account may be ranked by the customer by using the pre-defined priority or pre-determined rules as described previously. In some embodiments, the customer may enter a selection indicator (e.g. 1, 2, 3 etc.) as part of the authorisation response so as to select one of the more than one secondary accounts for use in processing the payment transaction. In this case, the selection indicator may be associated with the more than one secondary accounts during a registration process.

The issuer server 110 is configured to receive an authorisation response from the customer via the customer electronic device 102 indicating if the payment transaction is to be processed using the customer financial asset. Once the authorisation response is received by the issuer server 110 (and any other checks (e.g. authentication of OTP) have been performed if necessary), the issuer server 110 is configured to transmit a transaction authorisation response to the payment network server 108, the transaction authorisation response indicating if the payment transaction is approved or refused. The payment network server 108 receives the transaction authorisation response, and in turn transmits the transaction authorisation response comprising an approval or a refusal for the payment transaction, to the merchant server 104 via the acquirer server 106. The merchant server 104 may notify the customer of a result of the payment transaction via the e-commerce website accessible to the customer electronic device 102 or via the POS terminal. The issuer server 110 may notify the customer that the payment amount (or a shortfall (i.e. a difference between the payment amount and the available balance in the primary account)) has been deducted from his/her secondary account if the payment transaction is successful. In some embodiments where a credit card is used in initiating the payment transaction, clearing and settlement processes are conducted subsequently to transfer funds from the customer account(s) (e.g. primary and/or secondary account) to the merchant account in a conventional way.

In some embodiments, the above described processes are carried out at the payment network server 108. For example, upon receiving the transaction authorisation request from the merchant server 104 via the acquirer server 106, the payment network server 108 may be configured to: (i) communicate with the issuer server 110 to determine if the available balance of the primary account is less than the payment amount; (ii) determine if the customer is associated with the secondary account which is associated with the customer financial asset if the available balance is less than the payment amount (e.g. this can be determined using a customer profile registered with the payment network database 114 where the customer profile may comprise a list of accounts (primary and/or secondary accounts) associated with the customer); (iii) transmit, to the customer via the customer electronic device 102, the authorisation request to process the payment transaction using the customer financial asset if the customer is associated with the secondary account; (iv) receive an authorisation response indicating if the payment transaction is to be processed using the customer financial asset from the customer via the customer electronic device 102; and (v) transmit the transaction authorisation response indicating if the payment transaction is approved or refused to the customer.

Although only one customer electronic device 102 and only one merchant server 104 is shown in FIG. 1, a plurality of customer electronic devices 102 and a plurality of merchant servers 104 associated with respective e-commerce sites or POS terminals may also form part of the computer system 100. Similarly, a plurality of acquirer servers 106 and a plurality of issuer servers 110 may also be in communication with the payment network server 108 and form part of the computer system 100. In some embodiments where the described processes are carried out at the payment network server 108, the primary account of the customer used in the payment transaction is maintained by an issuer institution (e.g. institution A) while the secondary account of the customer is maintained by another issuer institution (e.g. institution B). In this case, the payment network server 108 may act as a central platform to facilitate use of financial assets of the customer from different accounts associated with different issuer institutions for processing the payment transaction. In other words, the secondary account (e.g. a commodity account) is linked with all other accounts which are associated with the customer. This advantageously provide for a way to utilise different financial assets of the customer which may reside with different issuer institutions. A skilled person in the art would be able to implement the above described steps on a plurality of secondary accounts (e.g. more than the two accounts, primary account and secondary account described above) to facilitate processing the payment transaction using more than one form of financial asset.

Communication between the customer electronic device 102, servers and databases 112, 114 may take place via any type of system, for example, a virtual private system (VPN), the Internet, a local area and/or wide area system (LAN and/or WAN), and so on.

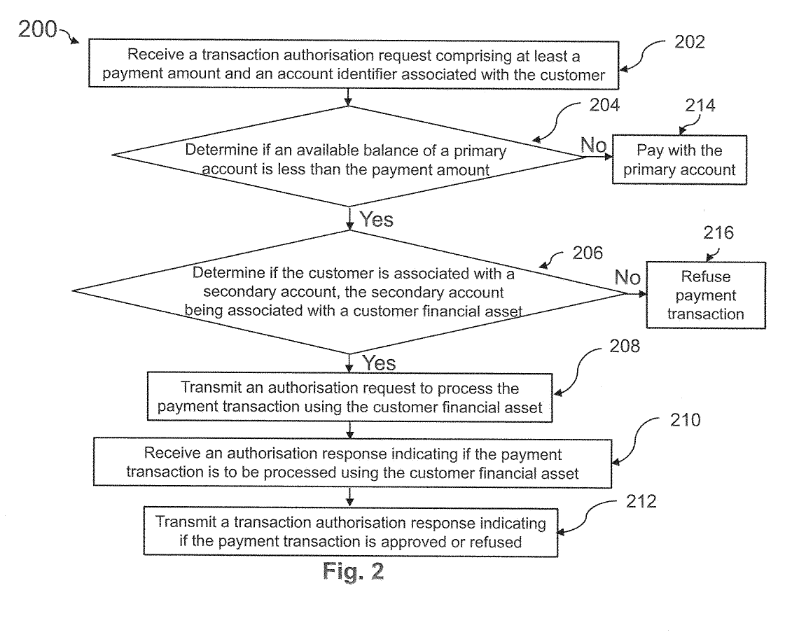

FIG. 2 shows steps of a method 200 for processing a payment transaction using various financial assets in accordance with an embodiment of the invention. The method 200 may be carried out using either the payment network server 108 or the issuer server 110 of the system 100 as shown in FIG. 1.

In a step 202, a server 108, 110 is configured to receive a transaction authorisation request comprising at least a payment amount and an account identifier associated with the customer. Where the server 108, 110 is the payment network server 108, the transaction authorisation request may be received from the merchant server 104 via the acquirer server 106. Where the server 108, 110 is the issuer server 110, the transaction authorisation request may be received from the payment network server 108. The payment amount is a monetary amount required from the customer in exchange for goods or services offered by the merchant in the payment transaction. The account identifier associated with the customer is a unique identifier which enables the server 108, 110 to identify at least the primary account used for processing the payment transaction. The account identifier may be one of the following: a bank account number, a payment card number or the like.

In a step 204, the server 108, 110 is configured to determine if an available balance of a primary account associated with the account identifier is less than the payment amount. Where the server 108, 110 is the payment network server 108, the payment network server 108 may be configured to communicate with the issuer server 110 to carry out the step 204. If it is determined that the available balance of the primary account is less than the payment amount, the server 108, 110 is configured to carry out a step 206 as described below. Otherwise, the server 108, 110 may be configured to process the payment transaction in a conventional manner using the available fund in the primary account in a step 214. In some embodiments, the server 108, 110 is configured to determine if the customer identifier is associated with more than one secondary account. Where it is determined that the customer identifier is associated with more than one secondary account, the server 108, 110 may be configured to determine if the more than one secondary account is associated with: (i) a pre-defined priority where the pre-defined priority are associated with the customer identifier and defines a priority for using the more than one secondary account in processing the payment transaction; and/or (ii) pre-determined rules where the pre-determined rules are associated with the customer identifier and are used for ranking the more than one secondary account in processing the payment transaction. The server 108, 110 may be configured to rank the more than one secondary account using the pre-defined priority or the pre-determined rules, where at least a highest ranking secondary account of the more than one secondary account is used in processing the payment transaction. In some embodiments, where it is determined that the customer identifier is associated with more than one secondary account, the server 108, 110 is configured to transmit a selection request to the customer electronic device to input a selection or ranking list of the more than one secondary account for use in processing the payment transaction, and to receive a selection response from the customer electronic device comprise the selection or ranking list of the more than one secondary account for use in processing the payment transaction, where at least a selected or highest ranking secondary account is used in processing the payment transaction. In some embodiments, the customer may enter a selection indicator (e.g. 1, 2, 3 etc.) as part of the authorisation response so as to select one of the more than one secondary accounts for use in processing the payment transaction. In this case, the selection indicator may be associated with the more than one secondary accounts during a registration process.

In the step 206, the server 108, 110 is configured to determine if the customer is associated with a secondary account if it is determined in the step 204 that the available balance of the primary account is less than the payment amount. The secondary account is associated with a customer financial asset. The customer financial asset may be one of the following: cash and cash equivalents, credit, securities, stocks/shares, commodities, bonds, fixed deposits, properties, equities, intellectual properties, goodwill, equipment, inventory, and a prepaid card.

In a step 208, the server 108, 110 is configured to transmit, to the customer electronic device 102, an authorisation request if it is determined that the customer is associated with the secondary account, the authentication request comprising a request to process the payment transaction using the customer financial asset. In some embodiments, the authorisation request may comprise a secondary authentication factor (e.g. a dynamic one-time-password (OTP)) which is transmitted from the issuer server 110 to the customer via the customer electronic device 102 to authenticate the customer for the authorisation request. Alternatively, if it is determined that the customer is not associated with any secondary account linked to a customer financial asset in the step 208, the server 108, 110 is configured to refuse the payment transaction in a step 216. In this case, the server 108, 110 may prompt the customer, via the merchant server 104, to provide another form of payment to complete the payment transaction.

In a step 210, the server 108, 110 is configured to receive, from the customer electronic device 102, an authorisation response indicating if the payment transaction is to be processed using the customer financial asset.

Once the server 108, 110 has received the authorisation response in the step 210, the server 108, 110 is configured to transmit a transaction authorisation response indicating if the payment transaction is approved or refused in a step 212. Where the server 108, 110 is the payment network server 108, the authorisation may be transmitted to the merchant server 104 via the acquirer server 106. Where the server 108, 110 is the issuer server 110, the transaction authorisation request may be transmitted to the payment network server 108 which may be subsequently forwarded to the merchant server 104 via the acquirer server 106.

Although the above method 200 demonstrates the use of the secondary account (e.g. an account associated with commodity or a customer financial asset) as a way to top-up payment for the payment transaction if it is determined in the step 204 that the available balance of the primary account is less than the payment amount, in some embodiments, the secondary account can be used as the primary account to pay for the payment transaction. In other words, the customer may use primarily his/her customer financial asset to pay for the payment transaction.

FIG. 3, comprising FIG. 3A and FIG. 3B, shows steps for registering to use various financial assets for processing the payment transaction in accordance with an embodiment of the invention, where FIG. 3A shows steps of a method 300 for registration of the customer and FIG. 3B illustrates a process flow 310 for registration of the customer. The method 300 may be carried out by the server 108, 110 of the system 100 as shown in FIG. 1. The details of the process flow 310 where the registration request is received at either the server 108, 110 is shown in FIG. 3B.

Referring to FIG. 3A, in a step 302, the server 108, 110 is configured to receive, from the customer electronic device 102, a registration request comprising a request to register to use various financial assets for processing the payment transaction. In some embodiments, to register to use various financial assets for processing the payment transaction, the customer is required to have at least one existing account with the issuer institution. The registration request may comprise at least details of the primary account (e.g. a primary account number, a name of the customer, details of the issuer institution associated with the primary account such as bank identification code (BIC) or a SWIFT code etc.) and details of the secondary account (e.g. a secondary account number, a name of the customer, details of the issuer institution associated with the secondary account such as bank identification code (BIC) or a SWIFT code, a financial asset type etc.). In some embodiments, the customer may be associated with more than one secondary account. The more than one secondary account may be associated with a pre-defined priority to determine an order of which the more than one secondary account may be used for processing the payment transaction. The more than one secondary account may be associated with pre-determined rules such that the rules can be used to determine which secondary account to utilise for processing the payment transaction. The pre-defined priority and/or the pre-determined rules may be determined or defined when the customer registers to use various financial assets for processing the payment transaction. In some embodiments, the pre-defined priority and/or the pre-determined rules may be comprised in the registration request. In some embodiments, the customer may enter a selection indicator (e.g. 1, 2, 3 etc.) as part of the authorisation response so as to select one of the more than one secondary accounts for use in processing the payment transaction. In this case, the selection indicator may be associated with the more than one secondary accounts via the registration request.

In a step 304, the server 108, 110 is configured to transmit, to the customer electronic device 102, a registration response indicating if the registration request is approved or refused. In some embodiments, to determine if the registration request is approved, the server 108, 110 is configured to verify the details associated with the primary account and the secondary account comprised in the registration request. Where the server 108, 110 is the payment network server 108, the payment network server 108 may be configured to communicate with the relevant issuer server(s) 110 associated with the primary account and the secondary account so as to verify the details associated with the primary account and the secondary account.

Referring to FIG. 3B, in a step 312, the customer transmits, via the customer electronic device 102, a registration request to the issuer server 110 to register to use various financial assets for processing the payment transaction. This is analogous to the step 302 where the registration request is received at the issuer server 110. After verifying that the customer has at least one existing account with the issuer institution and that the necessary information as discussed above in relation to the step 302 has been received via the registration request, the issuer server 110 updates a customer profile associated with the customer at the issuer database 112. In some embodiments, updating the customer profile includes providing preferences for use of the customer financial asset associated with the secondary account. For example, the customer defines a price margin in which the customer financial asset can be sold in order to provide funds for the payment transaction. Other options or preferences are discussed below.

In a step 314, the issuer server 110 is configured to transmit, to the customer electronic device 102, the registration response as discussed in the step 304. The registration response serves to notify the customer if the registration has been successful. In some embodiments, the customer profile stored in a mobile application of the customer electronic device 102 is updated upon successful registration of the customer to use various financial assets for processing the payment transaction.

Alternatively, in a step 316, the customer transmits, via the customer electronic device 102, a registration request to the payment network server 108 to register to use various financial assets for processing the payment transaction. This is analogous to the step 302 where the registration request is received at the payment network server 108. In some embodiments, the payment network server 108 verifies that the customer is associated with at least one customer account registered with the payment network server 108. Once the necessary information (e.g. details of the secondary account) as discussed above in relation to the step 302 has been received via the registration request, the payment network server 108 updates a customer profile associated with the customer at the payment network database 114. In some embodiments, updating the customer profile includes providing preferences for use of the customer financial asset associated with the secondary account. For example, the customer defines a price margin in which the customer financial asset can be sold in order to provide funds for the payment transaction. Other options or preferences are discussed below.

In a step 318, the payment network server 108 is configured to transmit, to the customer electronic device 102, the registration response as discussed in the step 304. The registration response serves to notify the customer if the registration has been successful. In some embodiments, the customer profile stored in a mobile application of the customer electronic device 102 is updated upon successful registration of the customer to use various financial assets for processing the payment transaction.

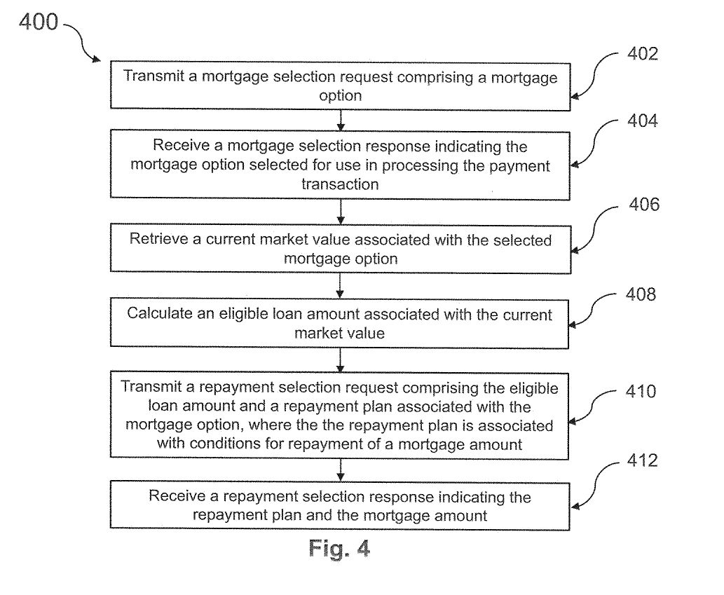

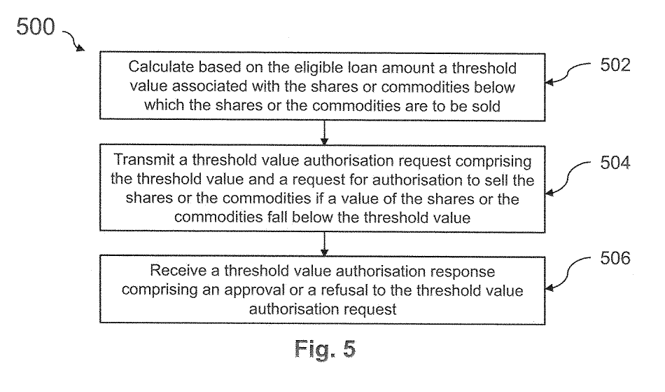

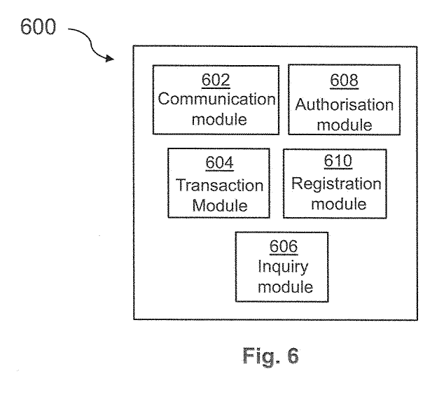

In some embodiments, using the customer financial asset for processing the payment transaction comprises selling or mortgaging shares or commodities. FIG. 4 shows additional steps for processing the payment transaction through selling shares or commodities, while FIGS. 5 and 6 shows additional steps for processing the payment transaction through mortgaging shares or commodities.

In some embodiments, processing the payment transaction through sale of the shares or the commodities is available during relevant trading windows associated with the shares or the commodities to be sold. The shares or the commodities may be sold and money derived from the sale of the shares or the commodities may be transferred to the primary account before the payment transaction can proceed using funds made available to the primary account. The money derived from the sale may be less than the actual market value of the shares or the commodities due to fees involved during processing of the sale of the shares or the commodities. In some embodiments, the customer is notified of current values of the shares or the commodities by the server 108, 110. This may be comprised in the authorisation request transmitted from the server 108, 110 to the customer via the customer electronic device 102 at the step 208. In some embodiments, the shares or the commodities are sold at the market value immediately. In other embodiments, the shares or the commodities may be held by the issuer institution associated with the secondary account and sold at a later time based on market trends. In these cases, the customer may receive money derived from the sale based on the market value of the shares or the commodities presented to him/her at the time of authorisation (e.g. in the step 208), while the issuer institution associated with the secondary account may bear the risk of selling the shares or the commodities at a later time. Various conditions may be defined by the customer and/or the issuer institution in regards to the sale of the shares or the commodities (see e.g. description below).

The server 108, 110 may be configured to receive, from the customer electronic device 102, price margins of the shares or the commodities within which the shares or the commodities are to be sold. The price margins of the shares or the commodities define the price ranges for each of the shares or the commodities within which the shares or the commodities may be sold. The price margin for a share or a commodity may be based on a percentage of the price at which the share or the commodity is bought or it may be a range of values. The price margin may be determined by the customer. In some embodiments, the price margins of the shares or the commodities are defined by the customer and received at the server 108, 110 at the time of registration of the customer. The customer may update or revise the price margins with the server 108, 110 at any time after registration.

The server 108, 110 may be configured to receive, from the customer electronic device 102, a selection of the shares or the commodities associated with the secondary account for use in processing the payment transaction. The selection of the shares or the commodities may be associated with specific shares or commodities which the customer has selected for use in processing payment transactions using financial assets. In other words, the customer may define certain set of shares or commodities which can be sold so as to provide funds for processing payment transactions. The selection of the shares or the commodities for use in processing the payment transaction may be received at the server 108, 110 at the time of registration of the customer, or it may be updated and received at the server 108, 110 at any other time after the customer has been registered.

FIGS. 4 and 5 show additional steps respectively in methods 400 and 500 for processing the payment transaction through mortgaging shares or commodities in accordance with embodiments of the invention. In some embodiments, processing the payment transaction through the mortgage of shares or commodities can be used during a relevant trading window associated with the shares or the commodities to be sold. Where using financial assets for processing payment transactions comprises mortgaging the shares or the commodities, the shares or the commodities mortgaged with the issuer institution are not sold (unless due to exceptional circumstances as a result of market fluctuations or the customer defaulting on a loan/mortgage) but kept by the issuer institution as a security for a loan/mortgage. Various conditions may be defined by the customer and/or the issuer institution in regards to the mortgage of the shares or the commodities.

Referring to FIG. 4, in a step 402, the server 108, 110 is configured to transmit, to the customer electronic device 102, a mortgage selection request comprising a mortgage option, the mortgage option being associated with mortgaging the shares or the commodities. In some embodiments, the customer is presented with two options for mortgaging his/her financial asset: (i) mortgage commodities and (ii) mortgage equities (or shares). The options may be presented to the customer via the customer electronic device 102 through an appropriate application (“App”).

In a step 404, the server 108, 110 is configured to receive, from the customer electronic device 102, a mortgage selection response indicating the mortgage option selected for use in processing the payment transaction. In other words, the server 108, 110 is configured to receive an instruction from the customer as to whether the customer wishes to mortgage the commodities or to mortgage the shares (or equities) associated with the secondary account.

In a step 406, the server 108, 110 is configured to retrieve a current market value associated with the selected mortgage option. Depending on the mortgage option selected for use in processing the payment transaction by the customer in the step 404, the server 108, 110 is configured to retrieve a current market value of the shares or the commodities used in processing the payment transaction. The server 108, 110 may be configured to do so by communicating with a server which has access to information related to relevant markets associated with the shares and/or the commodities.

In a step 408, the server 108, 110 is configured to calculate an eligible loan amount associated with the current market value of the selected mortgage option. The eligible loan amount may represent an upper limit to a monetary value for which the customer may loan using his/her shares or commodities. The eligible loan amount may be specific to the shares or the commodities which the customer has selected for use in processing payment transactions using financial assets. The shares or the commodities for use may be specified at the time of registration of the customer or updated at any time after the customer has been registered. In some embodiments, an eligible loan amount for each of the shares or the commodities is calculated by the server 108, 110 and presented to the customer. In some embodiments, a total eligible loan amount for each mortgage option is calculated by the server 108, 110 and presented to the customer, the total eligible loan amount being a sum of all the eligible loan amounts for the shares (if mortgaging the shares is selected) or a sum of all the eligible loan amounts for the commodities (if mortgaging the commodities is selected). Where the processes described above (e.g. the methods 200 to 400) are carried out at the payment network server 108, calculation of the eligible loan amount may be carried out at the issuer server 110 associated with the issuer institution which maintains the secondary account. In these cases, the payment network server 108 may be configured to receive the calculated eligible loan amount from the issuer server 110 and transmit it to the customer in a step 410.

In the step 410, the server 108, 110 is configured to transmit, to the customer electronic device 102, the eligible loan amount and a repayment selection request comprising a repayment plan associated with the mortgage option, the repayment plan is associated with conditions for repayment of a mortgage amount, the mortgage amount is a monetary amount being loaned to the customer by mortgaging the shares or the commodities. Some examples of a repayment plan are: (i) repay the mortgage amount in a single repayment after a predetermined period (e.g. 30 days) with a predetermined amount of interest (e.g. 5%); (ii) repay the mortgage amount via equated monthly installments in a predetermined number of months (e.g. 12 months) with a predetermined amount of interest (e.g. 8%); and (iii) repay the mortgage amount at a predetermined margin level by selling equities (i.e. shares) or commodities at a targeted amount on a predetermined profit sharing basis. For option (i), the predetermined amount of interest may be adjusted depending on the predetermined period. The predetermined period may be determined by the customer. For example, the predetermined amount of interest may be higher if the predetermined period is longer. For option (ii), the predetermined number of months for installments may be determined by the customer. Similar to option (i), the predetermined amount of interest may be adjusted depending on the predetermined number of months for installments. The predetermined amount of interest may be 1%, 2%, 3%, 5%, 8%, 10%, 15%, 20% or any reasonable amount. For option (iii), the predetermined margin level may be determined by either the customer or the issuer institution associated with the secondary account, where the predetermined margin level defines a price range for which the equities/shares or the commodities may be sold. The predetermined profit sharing basis may be determined by the issuer institution associated with the secondary account. In this case, once the equities/shares or the commodities are sold within the predetermined margin level, a portion of the profit (as defined by the predetermined profit sharing basis) may be credited to the issuer institution associated with the secondary account as a form of interest for the mortgage.

In some embodiments, the mortgage amount is less than or equal to the eligible loan amount. The mortgage amount may be a portion of the payment amount or the full payment amount associated with the payment transaction. The mortgage amount may be a shortfall amount (i.e. a monetary amount equal to a difference between the payment amount and the available balance of the primary account for the payment transaction). In some embodiments, the mortgage amount is more than the payment amount associated with the payment transaction. In these cases, the customer may be able to acquire more liquidity (e.g. in the form of cash) than the payment amount associated with the payment transaction. In some embodiments, the repayment selection request comprises an agreement which the customer is required to sign (digitally or physically) before the mortgage can be executed. In some embodiments, the customer is presented risk factors associated with the mortgage of shares or commodities where the customer is notified that he/she is to bear the risks of market fluctuations. The agreement which the customer is required to execute may comprise an agreement for the issuer institution associated with the secondary account to sell the mortgaged shares or the mortgaged commodities if the mortgaged shares or the mortgaged commodities fall below a predetermined value (see e.g. FIG. 5 for more detail).

In a step 412, the server 108, 110 is configured to receive, from the customer electronic device 102, a repayment selection response indicating the repayment plan and the mortgage amount selected by the customer. In some embodiments, the repayment plan is not defined based on the mortgage amount. In these cases, the customer may select a suitable repayment plan as described above and input the mortgage amount for the repayment plan in the step 412. In some embodiments where the repayment plan changes depending on the mortgage amount, the server 108, 110 is configured to transmit, to the customer electronic device 102, a mortgage amount request for the mortgage amount for a mortgage, and to receive a mortgage amount response comprising the mortgage amount for the mortgage from the customer electronic device 102 between the steps 408 and 410. In this case, the repayment selection request in the step 410 may comprise a repayment plan specific for the mortgage amount received from the customer electronic device 102.

Referring to FIG. 5, in a step 502, the server 108, 110 is configured to calculate, based on the eligible loan amount, a threshold value associated with the shares or the commodities below which the shares or the commodities are to be sold. The threshold value acts as a safety net for the issuer institution associated with the secondary account in light of volatility in a value of the stocks and/or the commodities. If it is determined that the value of the shares or the commodities fall below the threshold value, the issuer institution may be authorised to sell the mortgaged shares or the mortgaged commodities to recoup the mortgage amount administered to the customer. Where the processes described (e.g. the methods 200 to 500) are carried out at the payment network server 108, calculation of the threshold value may be carried out at the issuer server 110 associated with the issuer institution which maintains the secondary account. In these cases, the payment network server 108 may be configured to receive the calculated threshold value and transmit it to the customer in a step 504. The threshold value may be calculated in a same step as the eligible loan amount at the issuer server 110 (although the threshold value may be calculated after the eligible loan amount) such that both the threshold value and the eligible loan amount may be transmitted to the payment network server 108 or known at the issuer server 110 at a same time.

In the step 504, the server 108, 110 is configured to transmit, to the customer electronic device 102, a threshold value authorisation request comprising the threshold value and a request for authorisation to sell the shares or the commodities if a value of the shares or the commodities fall below the threshold value.

In a step 506, the server 108, 110 is configured to receive, from the customer electronic device 102, a threshold value authorisation response comprising an approval or a refusal to authorise selling the shares or the commodities if the value of the shares or the commodities fall below the threshold value. Where the processes described above (e.g. the methods 200 to 500) are carried out at the payment network server 108, the payment network server 108 may be configured to transmit the threshold value authorisation response to the issuer server 110 associated with the secondary account.

In some embodiments, the method 500 is carried out by the server 108, 110 before the step 410 so that the necessary information is presented to the customer at the time of transmitting the repayment selection request in the step 410.

In some embodiments, additional conditions are determined by the customer when he/she registers to use his/her secondary account(s) associated with customer financial assets for processing payment transactions. Some conditions may be determined by the issuer institution associated with the secondary account(s). These conditions (as described below) may be applicable in the case of selling of shares/commodities and/or the case of mortgaging shares/commodities. For example, the payment network server 108 or the issuer server 110 associated with the issuer institution maintaining the secondary account may set a transaction threshold associated with processing the payment transaction using the shares or the commodities. The transaction threshold is a maximum amount in which the payment transaction can be made using the shares or the commodities, whether by selling or mortgaging the shares or the commodities. The transaction threshold may be calculated based on a profile of the customer, where the profile of the customer may be associated with (i) a total value of the financial assets associated with the customer (at least as known to one issuer institution), (ii) a credit history of the customer, and/or (iii) an income of the customer.

In some embodiments, the customer determines a list of the shares or the commodities in order of preference for use in processing payment transactions using financial assets. In these cases, the server 108, 110 is configured to receive, from the customer electronic device 102, an equity priority list comprising the list of the shares or the commodities in order of preference for use in processing the payment transaction. The equity priority list may comprise a list of existing shares or commodities associated with the customer which he/she opts to use for processing payment transactions in an event where the available balance of the primary account is insufficient in completing the payment transaction. The equity priority list may include a portion of the shares or the commodities associated with the customer. The customer may also determine the limit of the shares to be used. For example, even if the customer has 100 shares of Share A available, he/she may opt to limit to 50 shares of the Share A for processing payment transactions using financial assets. The equity priority list may be received from the customer at the time of registration and may be updated by the customer from time to time after the customer is registered with the server 108, 110.

In some embodiments, the customer determines a list of payment options in order of preference for use in processing payment transactions using financial assets. The list of payment options may comprise a credit card, a debit card, shares, commodities and/or fixed deposits. In these cases, the server 108, 110 is configured to receive, from the customer electronic device 102, a payment priority list comprising the list of payment options in order of preference for use in processing the payment transaction via at least the primary account and the secondary account. For example, the customer may include in the payment priority list to use payment options such as (i) mortgage shares, (ii) sell shares and (iii) use fixed deposits in this descending order of priority as the secondary account if it is determined that the primary account associated with the customer has insufficient fund in completing the payment transaction. This thus advantageously provides multiple fallback options for the customer in funding the payment transaction even if he/she has insufficient funds in the primary account.

In some embodiments, the server 108, 110 or the customer determines a type of transaction which will be considered for processing using financial assets as described in the preceding methods. For example, the above methods of using financial assets for processing payment transactions may be applicable only for a purchase of other shares/commodities such as gold, silver, titanium etc.

The customer may determine if the secondary account (e.g. the proceeds from the mortgage or the sale of the shares or the commodities) is to be used to pay for the payment transaction in full or to pay only for a shortfall of the payment transaction (i.e. the difference between the available balance of the primary account and the payment amount).

FIG. 6 shows schematically a structure 600 of the server 108, 110 comprised in the computer system 100 in accordance with embodiments of the invention. The structure 600 of the server 108, 110 comprises a communication module 602, a transaction module 604, an inquiry module 606, an authorisation module 608 and a registration module 610.

The communication module 602 is configured to enable the server 108, 110 to communicate with at least the customer electronic device 102 as provided in the computer system 100. If the server 108, 110 is the payment network server 108, the communication module 602 is configured to enable the payment network server 108 to communicate with the acquirer server 106, the issuer server 110 and the customer electronic device 102. If the server 108, 110 is the issuer server 110, the communication module 602 is configured to enable the issuer server 110 to communicate with the payment network server 108 and the customer electronic device 102. The communication module 602 is configured to work in tandem with other modules of the server 108, 110 as discussed in more detail below.

The transaction module 604 is configured to work with the communication module 602 to receive the transaction authorisation request comprising at least the payment amount associated with the payment transaction and the account identifier associated with the customer, and to transmit the transaction authorisation response indicating if the payment transaction is approved or refused. In some embodiments where the above described methods are processed at the payment network server 108, the transaction authorisation request is received from and the transaction authorisation response is transmitted to the acquirer server 106. In some embodiments where the above described methods are processed at the issuer server 110, the transaction authorisation request is received from and the transaction authorisation response is transmitted to the payment network server 108 where they may be subsequently forwarded to the merchant server 104 via the acquirer server 106. The transaction module 604 may be configured to set the transaction threshold associated with processing the payment transaction using the shares or the commodities. The transaction module 604 may be configured to calculate the transaction threshold based on a profile of the customer where the profile of the customer may be associated with a total value of the financial assets associated with the customer, the credit history of the customer, and/or the income of the customer. Where it is determined by the inquiry module 606 that the customer identifier is associated with more than one secondary account, and that the more than one secondary account is associated with a pre-defined priority or pre-determined rules, the transaction module 604 may be configured to rank the more than one secondary account using the pre-defined priority or the pre-determined rules, where at least a highest ranking secondary account of the more than one secondary account is used in processing the payment transaction. In some embodiments, where it is determined that the customer identifier is associated with more than one secondary account, the transaction module 604 is configured to transmit a selection request to the customer electronic device to input a selection or a ranking list of the more than one secondary account for use in processing the payment transaction, and to receive a selection response from the customer electronic device comprising the selection or ranking list of the more than one secondary account for use in processing the payment transaction, where at least a selected or highest ranking secondary account is used in processing the payment transaction. In some embodiments, the customer may enter a selection indicator (e.g. 1, 2, 3 etc.) as part of the authorisation response so as to select one of the more than one secondary accounts for use in processing the payment transaction.

The inquiry module 606 is configured to determine if the available balance of the primary account associated with the account identifier is less than the payment amount, and to determine if the customer (via the account identifier) is associated with the secondary account if the available balance of the primary account is less than the payment amount. In some embodiments where the above described processes are carried out at the payment network server 108, the payment network server 108 is configured to act as a central platform. In these cases, the inquiry module 606 of the payment network server 108 is configured to work with the communication module 602 of the payment network server 108 to enquire about the available balance of the primary account from the issuer server 110 associated with the primary account, and to determine if the available balance of the primary account is less than the payment amount. The inquiry module 606 of the payment network server 108 may be configured, using the registered profile of the customer, to determine if the customer is associated with the secondary account. In some embodiments, the secondary account is not maintained by the same issuer institution as the primary account. In these cases, the inquiry module 606 and the communication module 602 of the payment network server 108 may be configured to work in tandem to communicate with the relevant issuer servers 110 to retrieve the necessary information accordingly. In some embodiments, the inquiry module 606 is configured to determine if the customer identifier is associated with more than one secondary account. Where it is determined that the customer identifier is associated with more than one secondary account, the inquiry module 606 may be configured to determine if the more than one secondary account is associated with: (i) a pre-defined priority where the pre-defined priority are associated with the customer identifier and defines a priority for using the more than one secondary account in processing the payment transaction; and/or (ii) pre-determined rules where the pre-determined rules are associated with the customer identifier and are used for ranking the more than one secondary account in processing the payment transaction. In some embodiments, the inquiry module 606 is configured to determine if the more than one secondary account is associated with a selection indicator (e.g. 1, 2, 3 etc.) comprised in the authorisation response so as to select one of the more than one secondary accounts for use in processing the payment transaction.

The authorisation module 608 is configured to work with the communication module 602 to transmit the authorisation request to the customer electronic device 102 if it is determined that the customer is associated with the secondary account, the authentication request comprising a request to process the payment transaction using the customer financial asset. The authorisation module 608 is configured to work with the communication module 602 to receive an authorisation response from the customer electronic device 102 indicating if the payment transaction is to be processed using the customer financial asset. In some embodiments where using the customer financial asset for processing the payment transaction comprises mortgaging the shares or the commodities, the authorisation module 608 is configured to work with the communication module 602 (when necessary) to: (a) transmit, to the customer electronic device 102, the mortgage selection request comprising the mortgage option, the mortgage option being associated with mortgaging the shares or the commodities; (b) receive the mortgage selection response indicating the mortgage option selected for use in processing the payment transaction from the customer electronic device 102; (c) retrieve the current market value associated with the selected mortgage option; (d) calculate the eligible loan amount associated with the current market value of the selected mortgage option; (e) transmit, to the customer electronic device 102, the repayment selection request comprising the eligible loan amount and a repayment plan associated with the mortgage option, where the repayment plan is associated with conditions for repayment of a mortgage amount and the mortgage amount is a monetary amount being loaned to the customer by mortgaging the shares or the commodities; and (f) receive the repayment selection response indicating the repayment plan and the mortgage amount selected by the customer from the customer electronic device 102. In some embodiments where the above described processes are carried out at the payment network server 108, the eligible loan amount in the step (d) above may be determined by the issuer server 110 associated with the secondary account. In this case, the authorisation module 608 of the payment network server 108 may be configured to work with the communication module 602 of the payment network server 108 to communicate with the issuer server 110 to receive the eligible loan amount. The authorisation module 608 may be configured to work with the communication module 602 (when necessary) to: (i) calculate, based on the eligible loan amount, the threshold value associated with the shares or the commodities below which the shares or the commodities are to be sold; (ii) transmit, to the customer electronic device 102, the threshold value authorisation request comprising the threshold value where the threshold value authorisation request comprises a request for authorisation to sell the shares or the commodities if a value of the shares or the commodities fall below the threshold value; and (iii) receive, from the customer electronic device 102, the threshold value authorisation response comprising an approval or a refusal to authorise selling the shares or the commodities if the value of the shares or the commodities fall below the threshold value. In some embodiments where the above described processes are carried out at the payment network server 108, the threshold value in the step (i) above may be determined by the issuer server 110 associated with the secondary account. In this case, the authorisation module 608 of the payment network server 108 may be configured to work with the communication module 602 of the payment network server 108 to communicate with the issuer server 110 to receive the threshold value.

The registration module 610 is configured to work with the communication module 602 to receive, from the customer electronic device 102, the registration request comprising a request to register to use various financial assets for processing the payment transaction, and to transmit, to the customer electronic device 102, the registration response indicating if the registration request is approved or refused. In some embodiments where using the customer financial asset for processing the payment transaction comprises selling the shares or the commodities, the registration module 610 is configured to work with the communication module 602 to receive: (i) price margins of the shares or the commodities within which the shares or the commodities are to be sold and (ii) the selection of the shares or the commodities associated with the secondary account for use in processing the payment transaction from the customer electronic device 102. The registration module 610 may be configured to work with the communication module 602 to receive: (i) the equity priority list comprising the list of shares or commodities in order of preference for use in processing the payment transaction and (ii) the payment priority list comprising the list of payment options in order of preference for use in processing the payment transaction via the secondary account, from the customer electronic device 102. The registration module 610 may be configured to work with the communication module 602 to receive: (i) the type of transaction eligible for processing using financial assets and (ii) information associated with a predetermined portion of the payment amount to be paid using the customer financial asset (e.g. a shortfall or a portion of the payment amount or the full payment amount) from the customer electronic device 102.

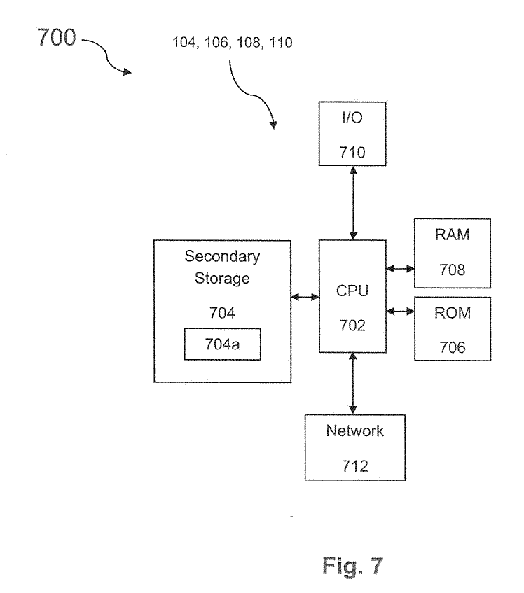

FIG. 7 is a block diagram showing a technical architecture of the payment network server 108. The issuer server 110 and/or the acquirer server 106 may also have this technical architecture. The merchant server 104 may share a similar technical architecture.

The technical architecture includes a processor 702 (which may be referred to as a central processor unit or CPU) that is in communication with memory devices including secondary storage 704 (such as disk drives), read only memory (ROM) 706, and random access memory (RAM) 708. The processor 702 may be implemented as one or more CPU chips. The technical architecture may further comprise input/output (I/O) devices 710, and system connectivity devices 712.

The secondary storage 704 is typically comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution.

In this embodiment, the secondary storage 704 has a processing component 704a comprising non-transitory instructions operative by the processor 702 to perform various operations of the method of the present disclosure. The ROM 706 is used to store instructions and perhaps data which are read during program execution. The secondary storage 704, the RAM 708, and/or the ROM 706 may be referred to in some contexts as computer readable storage media and/or non-transitory computer readable media.

I/O devices 710 may include printers, video monitors, liquid crystal displays (LCDs), plasma displays, touch screen displays, keyboards, keypads, switches, dials, mice, track balls, voice recognizers, card readers, paper tape readers, or other input devices.

The system connectivity devices 712 may take the form of modems, modem banks, Ethernet cards, universal serial bus (USB) interface cards, serial interfaces, token ring cards, fiber distributed data interface (FDDI) cards, wireless local area system (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other system devices. These system connectivity devices 712 may enable the processor 712 to communicate with the Internet or one or more intranets. With such a system connection, it is contemplated that the processor 702 might receive information from the system, or might output information to the system in the course of performing the above-described method operations. Such information, which is often represented as a sequence of instructions to be executed using processor 702, may be received from and outputted to the system, for example, in the form of a computer data signal embodied in a carrier wave.

The processor 702 executes instructions, codes, computer programs, scripts which it accesses from hard disk, floppy disk, optical disk (these various disk based systems may all be considered secondary storage 704), flash drive, ROM 706, RAM 708, or the system connectivity devices 712. While only one processor 702 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a system connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 702, the RAM 708, and the ROM 706 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A server for processing a payment transaction initiated by a customer using various financial assets, the server comprising:
a transaction module configured to:
receive a transaction authorisation request comprising at least a payment amount associated with the payment transaction and an account identifier associated with the customer; and
transmit a transaction authorisation response indicating if the payment transaction is approved or refused;
an inquiry module configured to:
determine if an available balance of a primary account associated with the account identifier is less than the payment amount; and
determine if the account identifier is associated with a secondary account if the available balance of the primary account is less than the payment amount, the secondary account being associated with a customer financial asset; and
an authorisation module configured to:
transmit, to a customer electronic device, an authorisation request if it is determined that the customer is associated with the secondary account, the authentication request comprising a request to process the payment transaction using the customer financial asset; and
receive, from the customer electronic device, an authorisation response indicating if the payment transaction is to be processed using the customer financial asset.

2. The server of claim 1, wherein using the customer financial asset for processing the payment transaction comprises mortgaging the shares or the commodities, the authorisation module is further configured to:
transmit, to the customer electronic device, a mortgage selection request comprising a mortgage option, the mortgage option being associated with mortgaging the shares or the commodities;
receive, from the customer electronic device, a mortgage selection response indicating the mortgage option selected for use in processing the payment transaction;
retrieve a current market value associated with the selected mortgage option;
calculate an eligible loan amount associated with the current market value of the selected mortgage option;
transmit, to the customer electronic device, a repayment selection request comprising the eligible loan amount and a repayment plan associated with the mortgage option, the repayment plan is associated with conditions for repayment of a mortgage amount, the mortgage amount is a monetary amount less than or equal to the eligible loan amount, which is being loaned to the customer by mortgaging the shares or the commodities; and
receive, from the customer electronic device, a repayment selection response indicating the repayment plan and the mortgage amount selected by the customer.

3. The server of claim 2, wherein the authorisation module is further configured to:
calculate, based on the eligible loan amount, a threshold value associated with the shares or the commodities below which the shares or the commodities are to be sold;
transmit, to the customer electronic device, a threshold value authorisation request comprising the threshold value and a request for authorisation to sell the shares or the commodities if a value of the shares or the commodities fall below the threshold value; and
receive, from the customer electronic device, a threshold value authorisation response comprising an approval or a refusal to authorise selling the shares or the commodities if the value of the shares or the commodities fall below the threshold value.

4. The server of claim 1, wherein the server further comprises a registration module configured to:
receive, from the customer electronic device, a registration request comprising a request to register to use various financial assets for processing the payment transaction; and
transmit, to the customer electronic device, a registration response indicating if the registration request is approved or refused.

5. The server of claim 4, wherein using the customer financial asset for processing the payment transaction comprises selling shares or commodities, the registration module is further configured to:
receive, from the customer electronic device, price margins of the shares or the commodities within which the shares or the commodities are to be sold.

6. A computer-implemented method for processing a payment transaction initiated by a customer using various financial assets, the method comprising:
receiving a transaction authorisation request comprising at least a payment amount associated with the payment transaction and an account identifier associated with the customer;
determining if an available balance of a primary account associated with the account identifier is less than the payment amount;
determining if the account identifier is associated with a secondary account if the available balance of the primary account is less than the payment amount, the secondary account being associated with a customer financial asset;
transmitting, to a customer electronic device, an authorisation request if it is determined that the customer is associated with the secondary account, the authentication request comprising a request to process the payment transaction using the customer financial asset;
receiving, from the customer electronic device, an authorisation response indicating if the payment transaction is to be processed using the customer financial asset; and
transmitting a transaction authorisation response indicating if the payment transaction is approved or refused.

7. The method of claim 6, wherein using the customer financial asset for processing the payment transaction comprises selling or mortgaging shares or commodities.

8. The method of claim 7, wherein using the customer financial asset for processing the payment transaction comprises mortgaging the shares or the commodities, the method further comprises:
transmitting, to the customer electronic device, a mortgage selection request comprising a mortgage option, the mortgage option being associated with mortgaging the shares or the commodities;
receiving, from the customer electronic device, a mortgage selection response indicating the mortgage option selected for use in processing the payment transaction;
retrieving a current market value associated with the selected mortgage option;
calculating an eligible loan amount associated with the current market value of the selected mortgage option;
transmitting, to the customer electronic device, a repayment selection request comprising the eligible loan amount and a repayment plan associated with the mortgage option, the repayment plan is associated with conditions for repayment of a mortgage amount, the mortgage amount is a monetary amount less than or equal to the eligible loan amount, which is being loaned to the customer by mortgaging the shares or the commodities; and
receiving, from the customer electronic device, a repayment selection response indicating the repayment plan and the mortgage amount selected by the customer.

9. The method of claim 8, further comprising:
calculating, based on the eligible loan amount, a threshold value associated with the shares or the commodities below which the shares or the commodities are to be sold;
transmitting, to the customer electronic device, a threshold value authorisation request comprising the threshold value and a request for authorisation to sell the shares or the commodities if a value of the shares or the commodities fall below the threshold value; and
receiving, from the customer electronic device, a threshold value authorisation response comprising an approval or a refusal to authorise selling the shares or the commodities if the value of the shares or the commodities fall below the threshold value.

10. The method of claim 7, further comprising setting a transaction threshold associated with processing the payment transaction using the shares or the commodities.

11. The method of claim 6, further comprising:
receiving, from the customer electronic device, a registration request comprising a request to register to use various financial assets for processing the payment transaction; and
transmitting, to the customer electronic device, a registration response indicating if the registration request is approved or refused.

12. The method of claim 11, wherein using the customer financial asset for processing the payment transaction comprises selling the shares or the commodities, the method further comprises:
receiving, from the customer electronic device, price margins of the shares or the commodities within which the shares or the commodities are to be sold.

13. The method of claim 11, wherein using the customer financial asset for processing the payment transaction comprises selling the shares or the commodities, the method further comprises:
receiving, from the customer electronic device, a selection of the shares or the commodities associated with the secondary account for use in processing the payment transaction.

14. The method of claim 7, further comprising receiving, from the customer electronic device, an equity priority list comprising a list of the shares or the commodities in order of preference for use in processing the payment transaction.

15. The method of claim 7, further comprising receiving, from the customer electronic device, a payment priority list comprising a list of payment options in order of preference for use in processing the payment transaction via at least the primary account and the secondary account, the list of payment options comprises a credit card, a debit card, shares, commodities and/or fixed deposits.

16. The method of claim 6, wherein the primary account is associated with another customer financial asset.

17. The method of claim 6, further comprising:
determining if the customer identifier is associated with more than one secondary account;
determining if the more than one secondary account is associated with a pre-defined priority, the pre-defined priority being associated with the customer identifier and defines a priority for using the more than one secondary account in processing the payment transaction; and
ranking the more than one secondary account using the pre-defined priority, wherein at least a highest ranking secondary account is used in processing the payment transaction.

18. The method of claim 6, further comprising:
determining if the customer identifier is associated with more than one secondary account;
determining if the more than one secondary account is associated with pre-determined rules, the pre-determined rules being associated with the customer identifier and used for ranking the more than one secondary account in processing the payment transaction; and
ranking the more than one secondary account using the pre-determined rules, wherein at least a highest ranking secondary account is used in processing the payment transaction.

19. The method of claim 6, further comprising:
determining if the customer identifier is associated with more than one secondary account;
receiving, from the customer electronic device, a selection indicator for selecting one of the more than one secondary account for use in processing the payment transaction.

20. A computer-implemented method for processing a payment transaction initiated by a customer using various financial assets, the method comprising:
receiving a transaction authorisation request comprising at least a payment amount associated with the payment transaction and an account identifier associated with the customer, the account identifier is associated with a customer asset account wherein the customer asset account is associated with a customer financial asset;
transmitting, to a customer electronic device, an authorisation request comprising a request to process the payment transaction using the customer financial asset;
receiving, from the customer electronic device, an authorisation response indicating if the payment transaction is to be processed using the customer financial asset; and
transmitting a transaction authorisation response indicating if the payment transaction is approved or refused.
